(19) United States
(12) Patent Application Publication
(10) Pub. No.: US 2005/0071365 A1
(43) Pub. Date: Mar. 31, 2005

(54) Method for keyword correlation analysis

(76) Inventors: Jiang-Liang Hou, Hsinchu City (TW); Chuan-An Chan, Toufen Township (TW)

Correspondence Address: J.C. Patents, Inc., Suite 250, 4 Venture, Irvine, CA, 92618, US

(21) Appl. No.: 10/786,702

(22) Filed: Feb. 24, 2004

(30) Foreign Application Priority Data
Sep. 26, 2003 (TW) 92126579

(51) Int. Cl. G06F 17/00

(52) U.S. Cl. 707/102

(57) ABSTRACT

A method for keyword correlation analysis is provided. The method obtains important words from a document repository, and then calculates correlations among the important words according to at least one of the occurring frequencies and occurring positions of the important words. Thereafter, keywords, which are highly correlated, can be obtained according to the correlations among the important words.

### CROSS-REFERENCE TO RELATED APPLICATION

This application claims the priority benefit of Taiwan application serial no. 92126579, filed on Sep. 26, 2003.

### BACKGROUND OF THE INVENTION

1. Field of the Invention

The present invention relates to a keyword extracting method, and more particularly, to a method for keyword correlation analysis.

2. Description of the Related Art

Recently, following the trend of the knowledge-based economy promoted by government, the enterprise have paid great attention to the knowledge, document or information management which is related to the enterprise business. In addition, since the great progress of the information and network techniques, the original time/space barrier for accessing knowledge or information is breached by the electronics technique, such that the user desiring information is able to promptly and freely acquire data.

It is summarized from the information provided by the papers previously disclosed, the keyword extracting technique can be classified into three major categories, they are the glossary comparison method, the parsing method, and the possibility statistic method. Wherein, the glossary comparison method extracts a certain phrase from a document as its keyword by using a built keyword glossary. The parsing method parses a certain phrase in the document by using the grammar parsing algorithm of the natural language processing technique, and further filters the inadequate words according to a deduction method and its associated criteria. The possibility statistic method extracts a certain phrase matched to the statistic parameters as its keyword after the statistic parameters are sufficiently accumulated and obtained by fully analyzing the document contents. Sproat and etc (1996) disclose a methodology regarding to the word segment, in such algorithm a sentence is segmented into a couple of meaningful words or phrases. Spark (1972) discloses a reserve way document frequency modification algorithm, which considers a document set and also includes the words for improving the keyword authentication effect. Sun Ming-Chung and Ho Chiang-Liang (2002) extract the keyword by using the glossary comparison method and the statistic analysis method so as to ensure the correctness of the keyword extraction.

Another important research of the keyword extraction in the conventional art discloses a data structure which is used to represent information, so as to facilitate the data search and data access operations (Hu Chau-Ming, 1998 and Bo Chiang-Chin, 1991). Jang Li-Fon (1999) builds a data structure, namely, PAT-Tree, in such data structure the keyword is extracted with the help of the statistic feature such as the occurring frequency of the words, however it takes a long period of time to process. Regarding to the keyword extraction, Jiang Jing-Ko (1994) discloses an optimal sorting method for processing a great amount of the keyword glossary, in such method, a big keyword glossary is divided into several sub glossaries of appropriate-size, and the method is applied on each sub glossary such that the keyword glossary of any amount can be dealt with.

Regarding to the keyword correlation analysis, Chen Kwan-Hwa discloses a query expansion (QE) method to improve the index search accuracy. Five experiments (including the base index, synonym glossary expansion, index glossary expansion, synonym glossary expansion and index glossary weighting, synonym glossary expansion and index glossary weighting and expansion) are designed in the method in order to verify the fact that the index glossary positively helps in correcting the noises of the synonym glossary expansion. Chen Kwan-Hwa and Chuang Ya-Jin (2001) also disclose a method for building a synonym correlation between two keywords with the number of the documents where the two keywords occur lonely and together. In such method, the synonym glossary and the index glossary which are formed automatically are used to perform the expansion of the keyword query, which is affirmed having a superior precision. Su and etc (2002) extract keyword and its property by analyzing the document with a vector space system model, wherein the keyword uses an “essential meaning” (the most essential and minimum atomic unit) to represent its concept, and the “essential meaning” may be used to form a plurality of concepts for resolving the problem of the one word multiple meanings or one meaning multiple words.

In summary, the disadvantages in the conventional art are as follows:
1. Chen Kwan-Hwa and Chuang Ya-Jin (2001) build a document correlation with the number of the documents where two keywords occur lonely and together. Although it can correctly obtain a keyword correlation, the expansion of the correlation query requires the synonym glossary and index glossary which are formed automatically, thus the query speed degrades with the increase of the glossary size due to the increase of the data amount.

2. Church and Hanks (1990) calculate a value of multiplying the possibility of two keywords occur together by the possibility of two keywords occur lonely. The disadvantage of the method is it only considers the possibility of the keyword occurring in the document, but ignores the fact that the keyword correlation in real case may be different due to the variance of the enterprise and document repository characteristics. Accordingly, only using the possibility of the keyword occurring in the document to calculate the correlation may affect its correctness due to the variance of the document repository and enterprise characteristics.

3. From the disadvantages mentioned above, it is known that the method for keyword correlation analysis in the conventional art requires the filed experts to manually determine the definition of the keyword with respect to the related field and its application field, and it is required to additionally build a giant correlation keyword repository. Therefore, the correlation of the keyword in the document can be obtained by using the correlation keyword repository which is manually built by the experts. However, the standards of the correctness of the correlated data corresponding to the correlation keyword repository are variant, and it is required to frequently maintain and update the correlated keywords for adapting to the variance of the physical environment. In addition, the meaning and application of a same keyword in different fields may be different, in order to be compatible to all correlated keywords and its correlated data, it is common that the correlated keyword repository has a great size. Moreover, the correlated keyword repository may not be suitable for every enterprise due to the variance of the different enterprise characteristics, and this is the major reason for why the related techniques cannot be introduced to the enterprise.

### SUMMARY OF THE INVENTION

In the light of the above problems, one object of the present invention is to provide a method for automatically analyzing the keyword correlation, the method is used to resolve the complexity in the conventional art, where the keyword correlation requires the field expert's manually judge and requires referring to a great amount of correlated keyword repository. The method for automatically analyzing keyword correlation is further applied to build up a correlated keyword repository which is suitable for the enterprises and its document repository application environment, and the correlated keyword repository is further applied to the operations of the industrial document and knowledge-based search, index classification, information comparison, meaning recognition and analysis. The method is not limited to specific application environment, thus it does not only mitigate the relying on the expert system when the enterprise is building up its own correlated keyword repository, but also effectively facilitate to build up the keyword repository which is exactly suitable for the enterprise operations. It is also applied to the enterprise knowledge-based and document management systems, so as to improve the practicality of the knowledge/document/information index, search and recognition.

The present invention provides a keyword correlation analysis method, the method comprises the steps of: obtaining a plurality of important words from a document repository; and then calculating a correlation among the important words according to at least one of the occurring frequencies and the occurring positions of the important words. Wherein, the steps for obtaining important words mentioned above may be one of the techniques as follows: word byte analysis, word phrase analysis, word phrase comparison, word phrase frequency maintenance, keyword extraction from the candidate glossary repository, and keyword extraction from the to-be-confirmed glossary repository.

In an embodiment of the present invention, the keyword correlation is calculated according to the occurring frequency of the important words. In the present embodiment, the occurring frequencies of the same important word are merged first, and the correlation of the merged occurring frequency of the important words is then calculated.

In an embodiment of the present invention, the step of merging the occurring frequencies of the same important word comprises the steps of: extracting a plurality of important words; then merging the keywords which repeatedly occur among the important words; and finally re-calculating the occurring frequency of the merged important words.

In an embodiment of the present invention, the step of re-calculating the occurring frequency of the merged important words comprises the steps of: obtaining the occurring frequency of the important words; then calculating a correlation factor of the occurring frequency among each two of the important words; and assigning the correlation factor as a correlation of the occurring frequency of the important words.

In another embodiment of the present invention, the correlation of the important words is calculated according to the occurring positions among the important words. In the present embodiment, a relative distance between the important words is calculated first, and a correlation of the occurring positions among the important words is calculated according to the relative distance of the important words.

In an embodiment of the present invention, the step of calculating the relative distance between the important words comprise: calculating a shortest distance between each of the occurring positions among the important words, respectively; and assigning the shortest distance as the relative distance.

In another embodiment of the present invention, the step of calculating the relative distance between the important words comprises the steps of: randomly selecting a first important word and a second important word from the important words; then calculating an non-used shortest distance between each of the occurring positions of the second important word and the first important word by using the first important word as a base, respectively; and finally assigning the non-used shortest distance as the relative distance mentioned above. Wherein, the non-used shortest distance is a shortest instance between a current position of the second important word and one of the occurring positions of the first important word, which is not used to calculate the relative distance with respect to any occurring position of the second important word.

In yet another embodiment of the present invention, the step of calculating a relative distance between the important words comprises the steps of: randomly selecting a first important word and a second important word from the important words; then calculating an subsequent shortest distance between each of the occurring positions of the second important word and the first important word by using the first important word as a base, respectively; and finally assigning the subsequent shortest distance as the relative distance mentioned above. Wherein, the subsequent shortest distance is a shortest instance between a current position of the second important word and one of the occurring positions of the first important word, which is subsequent to the previous occurring position used to calculate the relative distance with respect to the second important word.

In an embodiment of the present invention, the step of calculating the correlation of the occurring positions of the important words comprises the steps of: obtaining a relative distance among the important words; then calculating a correlation factor of the relative distances among the important words; and finally assigning the correlation factor as the correlation of the occurring positions of the important words.

In another embodiment of the present invention, a correlation of the important words is further calculated according to both the occurring frequencies and occurring positions of the important words. In the present embodiment, a correlation of the occurring frequencies and a correlation of the occurring positions among each two of the important words is calculated, respectively; then the correlation of the occurring frequencies and the correlation of the occurring positions among each two of the important words are multiplied; and finally the result of the multiplication is assigned as the correlation among each two of the important words.

In addition, in another embodiment of the present invention, a filtering operation is further performed in the step of calculating the correlated keywords. In the present embodiment, an initial set and a merge set are set up initially, the correlations among each two of the important words are sorted in a descending order, and the important words are put into the initial set. Then, the filtering operation sequentially merges the important words and obtains a corresponding merge frequency according to the sorting order of the correlations. When the merge frequency is greater or equal to a first predetermined value and the important word is not in the merge set, the important word is put into the merge set, and the steps are repeatedly performed until all important words in the initial set are sequentially merged and put into the merge set. After the merge operation is completed, if the difference of the number of the important words in the merge set and the number of the important words in the initial set is greater than a certain second predetermined value, the initial set is emptied and the important words in the merge set are put back to the initial set, then the merge set is emptied and the above steps are performed again. Otherwise, the important words in the initial set or in the merge set are assigned as the filtered keywords.

Typically, the occurring frequency of the high-correlation keywords occurring in the same document tends to be a positive correlation, for example, the keyword “sales” frequently occurs in the document introducing the “marketing”, thus the keywords “marketing” and “sales” are highly correlated. In addition, the definition of a same keyword for different people with various professional expertises or culture backgrounds may be different due to the fact of the versatile society. In other words, a keyword may be explained in broad sense or in narrow sense. For example, the “supply chain” in broad sense indicates a whole system composed of units from its upstream suppliers to its downstream demand units, whereas the “supply chain” in narrow sense only indicates a system composed of an enterprise and its upstream suppliers, wherein the system composed of the downstream demand units is referred as a “demanding chain”. On the perspective of the “supply chain” meaning in broad sense, the “supply chain” is correlated to the “demanding chain”, thus the occurring frequencies for such keywords occurring in the document is commonly correlated.

Therefore, with the above methods provided by the present invention, it does not only replace the relying on the manually judge of the field expert for building the keyword correlation so as to mitigate the relying on the field expert, but also facilitate to automatically build up a correlated keyword repository which is suitable for the enterprise or the electronic document repository application environment, such that the complexity of manually building the system can be eliminated and the case of miss generating a correlated keyword repository which is not suitable for the enterprise or document repository due to the human been miss judge or other errors can be avoided. Furthermore, unlike the glossary comparison method in which the keywords have to be continuously added into the correlated keyword repository in order to comply with all correlations, the correlated keyword repository formed by the method according to the present invention dose not have to do so, such that the annoyance for managing the keyword repository can be eliminated. Moreover, by using the judge on the occurring positions between two keywords, the poor correctness problem caused by the judge method which only judges the number of the documents where the keyword occurs and the possibility of the keyword occurrence can be avoided.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a flow chart illustrating a keyword correlation analysis method according to a preferred embodiment of the present invention.

FIG. 2 is a flow chart illustrating a method for selecting important words according to a preferred embodiment of the present invention.

FIG. 3 is a flow chart illustrating a method for performing the step S104 of FIG. 1 according to a preferred embodiment of the present invention.

FIG. 4A-4D are schematic diagrams showing the data obtained according to the flow chart of FIG. 3.

FIG. 5A is a flow chart illustrating a method for calculating the relative distance among each of the important words according to a preferred embodiment of the present invention.

FIG. 5B is a flow chart illustrating a method for calculating the relative distance among each of the important words according to another preferred embodiment of the present invention.

FIG. 5C is a flow chart illustrating a method for calculating the relative distance among each of the important words according to yet another preferred embodiment of the present invention.

FIG. 6 is a schematic diagram showing a data correlation obtained according to a preferred embodiment of the present invention.

FIG. 7 is a flow chart illustrating a method for building a keyword repository according to a preferred embodiment of the present invention.

### DESCRIPTION OF THE PREFERRED EMBODIMENTS

In order to have one of the ordinary skill in the art easily understand the spirit of the technique in the present invention, herein the symbols used in the document are defined as follows:
Dᵢ The i^{th} document in the document repository
KWᵢⱼ The j^{th} important word of the i^{th} document
KW_{i•} A set composed of all important words in the i^{th} document
N(Dᵢ, Vᵢ) The occurrence number of the j^{th} important word in the i^{th} document
N(Dᵢ, Vᵢ) The occurrence number of the important word Vᵢ in the i^{th} document
N_{D} The total number of documents in the document repository
NKᵢ The total number of the important words in the i^{th} document
NKᵥ The total number of the merged important words
V A union of the important words in all documents, i.e. {KW_{1•}∪KW_{2•} . . . ∪KW_{k•}}
Vᵢ The i^{th} important word of the set V
Li,m The m^{th} position of the i^{th} important word
\overline{L}ᵢ The mean position of the i^{th} important word in the determined object document

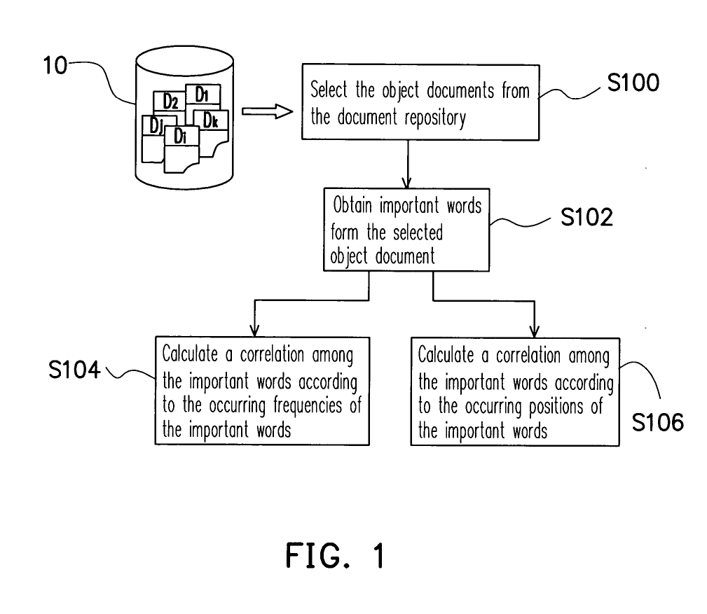

FIG. 1 is a flow chart illustrating a keyword correlation analysis method according to a preferred embodiment of the present invention. In the present embodiment, the object documents (D₁, D₂, . . . , Dᵢ, Dⱼ, Dₖ) to be processed are read into memory from a document repository 10 (step S100). Then, the important words in each object document are sequentially extracted from the selected object documents. (step S102). After all important words are extracted, a correlation among the important words is calculated according to the occurring frequencies of the important words (step S104). Alternatively, the correlation among the important words is calculated according to the occurring positions of the important words (step S106). In addition, the correlation among the important words may be calculated according to both the occurring frequencies and the occurring positions.

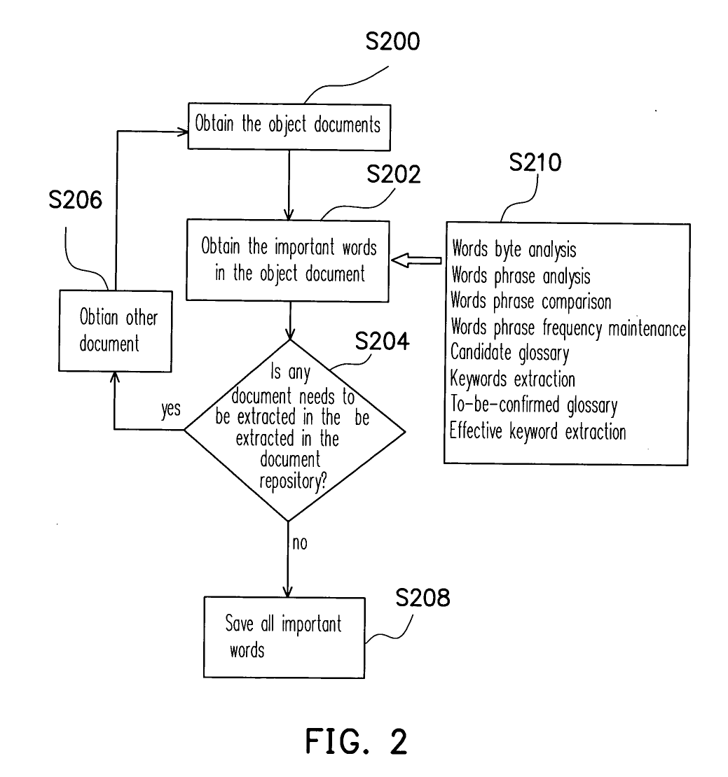

FIG. 2 is a flow chart illustrating a method for selecting important words according to a preferred embodiment of the present invention. In the present embodiment, the object documents are obtained (step S200). Then, the important words in the object documents are extracted by using one of the techniques as follows: word byte analysis, word phrase analysis, word phrase comparison, word phrase frequency maintenance, keyword extraction from the candidate glossary repository, and keyword extraction from the to-be-confirmed glossary repository (step S210). Then, it is determined whether the important words in all the object documents to be processed in the document repository are extracted (step S204), if there exists some object documents containing the important words which are not extracted yet, the object document having the remaining important words is selected by performing the step S206, and the process returns to step S200 where the important words are extracted again. Otherwise, if it is determined that there is no document needs to be extracted in step S204, the extracted keywords are saved (step S208).

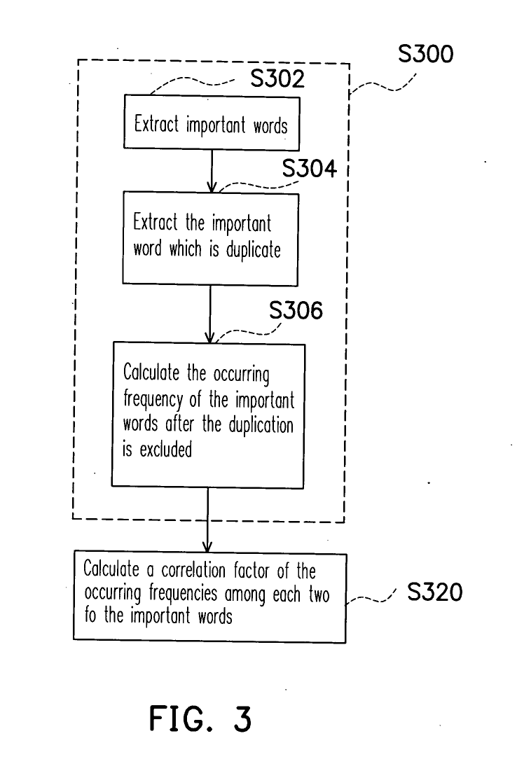

FIG. 3 is a flow chart illustrating a method for performing the step S104 of FIG. 1 according to a preferred embodiment of the present invention. In the present embodiment, when calculating a correlation among each of the important words according to the occurring frequencies of the important words, the occurring frequencies of the same keyword are merged first (step S300). Then, a correlation of the occurring frequencies of the merged important words is calculated.

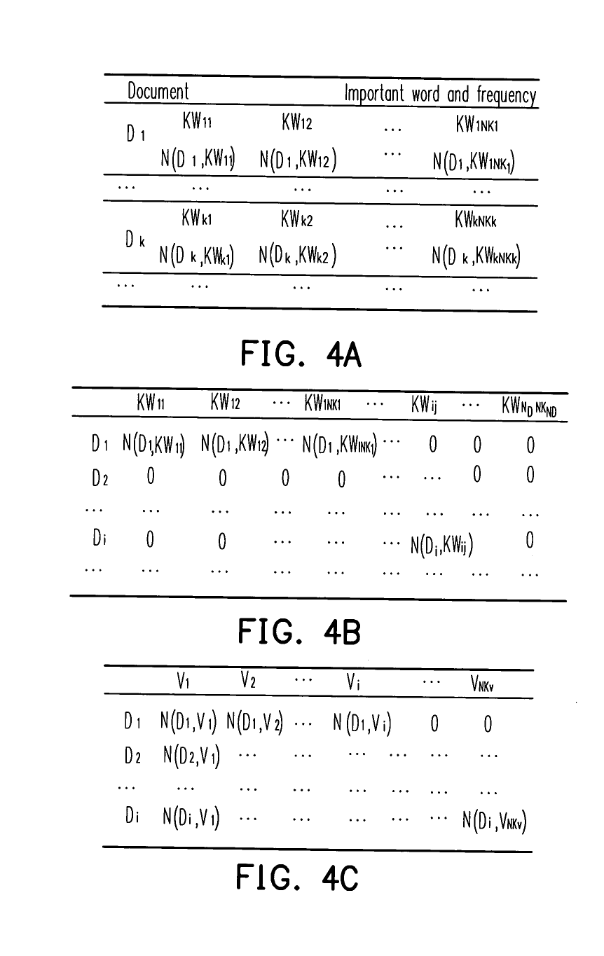

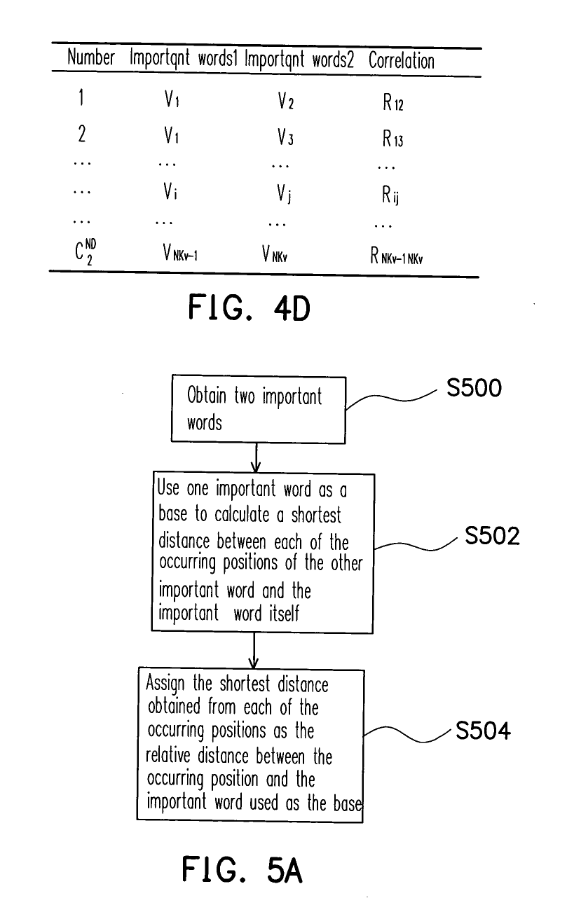

In the present embodiment, in order to merge the occurring frequencies of all of the same important words, the important words are extracted first (step S302), and then the keywords which repeatedly occur are merged (step S304). For a real example, since the important words extracted from each of the object documents may be duplicate (i.e., KWₗₘ=KWₖₙ and l≠k, in the words, the m^{th} important word of the document Dₗ has the same meaning with the n^{th} important word of the object document Dₖ), thus after the important words shown in FIG. 4A are all extracted, the important words are merge as shown in FIG. 4B. After the occurring frequencies of the same important words are further merged, the important words are as shown in FIG. 4C. Wherein, the occurring frequencies of the important words shown in FIG. 4C are based on a set (V) composed of all important words rather than according to the important words in a single object document as in the conventional art. Meanwhile, the occurring frequency of the merged important words is obtained from FIC. 4C (step S306).

After obtaining a summary table of the occurring frequencies of the important words as shown in FIG. 4C, the correlations among each two of the important words in the table are analyzed (step S320). In order to calculate the correlation R⁽¹⁾ᵢⱼ between Vᵢ and Vⱼ, a method for calculating the correlation is applied in the present embodiment. The equation used to calculate it is as follows:

$${R}_{ij}^{( 1 )} = \frac{{\sum }_{l = 1}^{{N}_{D}} {X}_{i , l} {X}_{j , l} - {N}_{D} \overline{{X}_{i} {X}_{j}}}{\sqrt{( {\sum }_{l = 1}^{{N}_{D}} {X}_{i , l}^{2} - {N}_{D} {\overline{X}}_{i}^{2} ) ( {\sum }_{l = 1}^{{N}_{D}} {X}_{j , l}^{2} - {N}_{D} {\overline{X}}_{j}^{2} )}}$$

Wherein, X_{i,j} is the occurring frequency of Vᵢ occurring in the document D₁ (it is also referred as a occurrence number), that is X_{i,1}=N(D₁, Vᵢ). The correlations among each two of the important words are obtained after the calculation mentioned above and are as shown in FIG. 4D.

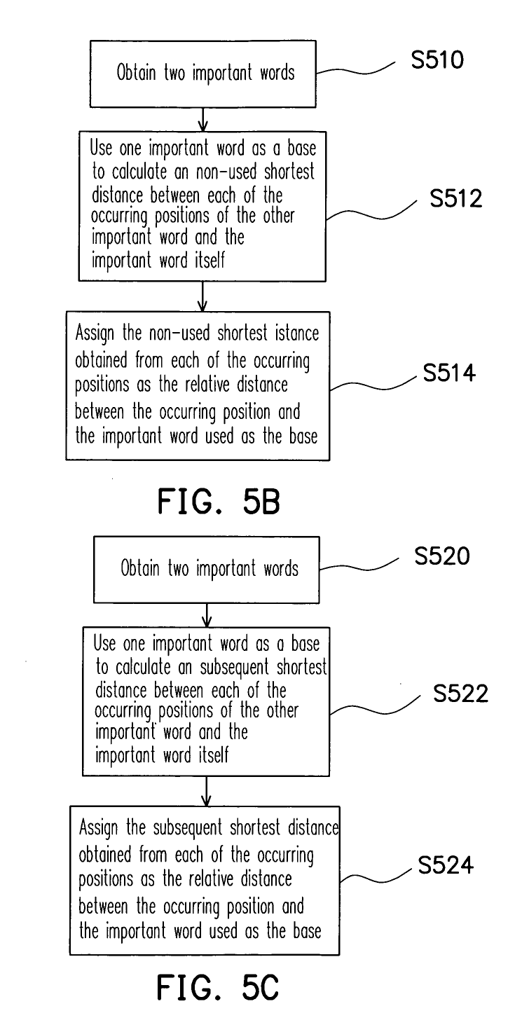

In another embodiment of the present invention, the correlation among each of the important words is calculated according to the occurring positions of the important words. In order to achieve this objective, the relative distance of each of the important words is calculated first, and the correlation of the occurring positions of each of the important words is calculated according to the calculated relative distances. FIG. 5A is a flow chart illustrating a method for calculating the relative distance among each of the important words according to a preferred embodiment of the present invention. In the present embodiment, two important words are extracted from the important words which are to be processed (step S500). It is assumed that the two important words are an important word (KWⱼ) with a lower occurring frequency and an important word (KWᵢ) with a higher occurring frequency, respectively, and the important word (KWᵢ) with a lower occurring frequency is used as a base, thus a shortest distance between two occurring positions is calculated by using following equation (step S502):

$$( m , am ) \vert \vert {L}_{i , m} - {L}_{j , am} \vert = {min}_{∀ n} \{ \vert {L}_{i , m} - {L}_{j , n} \vert \} ,$$

for all m.

In other words, in the present embodiment, a shortest distance between a current occurring position of the important word (KWᵢ) and any one of the occurring positions of the important word (KWⱼ) is calculated first, then the shortest distance is used as a relative distance between a current occurring position of the important word (KWᵢ) and important word (KWⱼ) (step S504).

It will be apparent to one of the ordinary skill in the art that although the above embodiment is based on the important word (KWⱼ) with a lower occurring frequency, with the same concept, the important word (KWᵢ) with a higher occurring frequency also can be used as a base for the calculation. In such case, a shortest distance between two occurring positions is calculated by using following equation (step S502):

$$( m , am ) \vert \vert {L}_{j , m} - {L}_{i , am} \vert = {min}_{∀ n} \{ \vert {L}_{j , m} - {L}_{i , n} \vert \} ,$$

for all m.

It is to be noted that by using such method, the different occurring positions of a same important word may repeatedly correspond to a same position of another important word.

Alternatively, another method is provided by the present invention to calculate the relative distance among each of the important words. FIG. 5B is a flow chart illustrating a method for calculating the relative distance among each of the important words according to another preferred embodiment of the present invention. In the present embodiment, two important words are extracted from the important words which are to be processed (step S500). It is assumed that the two important words are an important word (KWⱼ) with a lower occurring frequency and an important word (KWᵢ) with a higher occurring frequency, respectively, and the important word (KWⱼ) with a lower occurring frequency is used as a base, thus a non-used shortest distance between two occurring positions is calculated by using following equation (step S512):

$$( m , am ) \vert \vert {L}_{i , m} - {L}_{j , am} \vert = {min}_{∀ n , {excludinga}_{1} , … {a}_{m - 1}} \{ \vert {L}_{i , m} - {L}_{j , n} \vert \} ,$$

for all m.

Here, the non-used shortest distance is a shortest distance between a current position of the important word (KWⱼ) and one of the occurring positions of the important word (KWⱼ) which has not been used for calculating the relative distance with respect to any one of the occurring positions of the important word (KWᵢ). Therefore, in the present embodiment, a shortest distance between the current occurring position of the important word (KWᵢ) and the occurring position of the important word (KWⱼ) which has not been corresponded to is calculated first, that is the non-used shortest distance is calculated first. Then, The non-used shortest distance is used as a relative distance between the current occurring position of the important word (KWᵢ) and the important word (KWⱼ) (step S514).

Similarly, it will be apparent to one of the ordinary skill in the art that although the above embodiment is based on the important word (KWⱼ) with a lower occurring frequency, with the same concept, the important word (KWᵢ) with a higher occurring frequency also can be used as a base for the calculation. In such case, a non-used shortest distance between two occurring positions is calculated by using following equation (step S512):

$$( m , am ) \vert \vert {L}_{j , m} - {L}_{i , am} \vert = {min}_{∀ n , {excludinga}_{1} , … {a}_{m - 1}} \{ \vert {L}_{j , m} - {L}_{i , n} \vert \} ,$$

for all m.

With such method, the different occurring positions of a same important word do not correspond to the same occurring position of another important word.

Alternatively, yet another method is provided by the present invention to calculate the relative distance among each of the important words. FIG. 5C is a flow chart illustrating a method for calculating the relative distance among each of the important words according to yet another preferred embodiment of the present invention. In the present embodiment, two important words are extracted from the important words which are to be processed (step S520). It is assumed that the two important words are an important word (KWⱼ) with a lower occurring frequency and an important word (KWᵢ) with a higher occurring frequency, respectively, and the important word (KWᵢ) with a lower occurring frequency is used as a base, thus a subsequent shortest distance between two occurring positions is calculated by using following equation (step S522):

$$( m , am ) \vert \vert {L}_{i , m} - {L}_{j , am} \vert = {min}_{∀ n > {a}_{m - 1}} \{ \vert {L}_{i , m} - {L}_{j , n} \vert \} ,$$

for all m.

Here, the subsequent shortest distance is a shortest distance between a current position of the important word (KWⱼ) and one of the occurring positions of the important word (KWⱼ) which is subsequent to the previous important word used for calculating the relative distance with respect to the important word (KWᵢ). In other words, if the 5^{th} occurring position of the important word (KWⱼ) is corresponded to the 2^{nd} occurring position of the important word (KWᵢ), only the occurring positions subsequent to the 5^{th} important word (KWⱼ) (including the 6^{th} and the subsequent positions) can be used as the base for calculating the subsequent shortest distance with respect to the 3^{rd} occurring position of the important word (KWᵢ). Therefore, in the present embodiment, a subsequent shortest distance between the current occurring position of the important word (KWᵢ) and the important word (KWⱼ) is calculated first. Then, The subsequent shortest distance is used as a relative distance between the current occurring position of the important word (KWᵢ) and the important word (KWⱼ) (step S524).

After the relative distance among each of the important words are obtained by using the method mentioned above or others, a correlation factor of the relative distances among the important words is further calculated, and each calculated correlation factor is assigned as the correlation R⁽2)ᵢⱼ among the occurring positions of the important words. For easily differentiate the match of the occurring positions of the important words which are obtained from calculating the relative distances, the (L*_{i,1}, L*_{j,a}_{₁}), (L*_{i,2}, L*_{j,a}₂), . . . , (L*_{i,C}_{_{i,j}}, L*_{j,a}_{_{Ci,j}}) are used to represent a total number of C_{i,j} match combinations between the important word (KWᵢ) and the important word (KWⱼ).

In the present embodiment, the equation for calculating the correlation is as follows:

$${R}_{ij}^{( 2 )} = \frac{{\sum }_{m = 1}^{{C}_{i , j}} {L}_{i , m}^{*} {L}_{j , {a}_{m}}^{*} - {C}_{i , j} \overline{{L}_{i}^{*} {L}_{j}^{*}}}{\sqrt{( {\sum }_{m = 1}^{{C}_{i , j}} {( {L}_{i , m}^{*} )}^{2} - {C}_{i , j} {\overline{{L}_{i}^{*}}}^{2} ) ( {\sum }_{m = 1}^{{C}_{i , j}} {( {L}_{j , {a}_{m}}^{*} )}^{2} - {C}_{i , j} {\overline{{L}_{j}^{*}}}^{2} )}} .$$

After the description of the above embodiments, it will be apparent to one of the ordinary skill in the art that the present invention provides the method for calculating the correlation among each of the important words according to the occurring frequencies and occurring positions, respectively. In addition, as mentioned above, the correlation among each of the important words can be calculated based on both the occurring frequencies and occurring positions in the present invention. In order to achieve this objective, a simplest method is provided by an embodiment of the present invention, where the correlation R⁽¹⁾ᵢⱼ is multiplied by the correlation R⁽²⁾ᵢⱼ so as to obtain the correlation Rᵢⱼ among the important words, that is:
Rᵢⱼ=Rᵢⱼ⁽¹⁾*Rᵢⱼ⁽²⁾

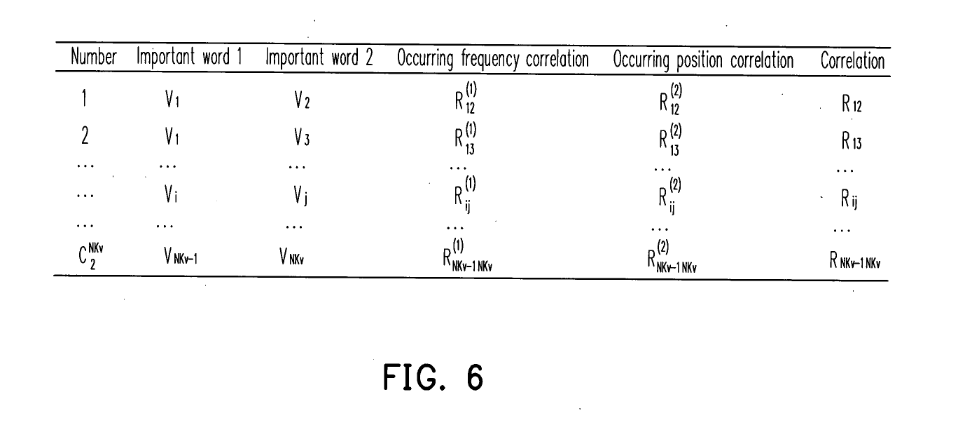

In summary, the data shown in FIG. 6 is obtained by applying the keyword correlation analysis method according to the present invention.

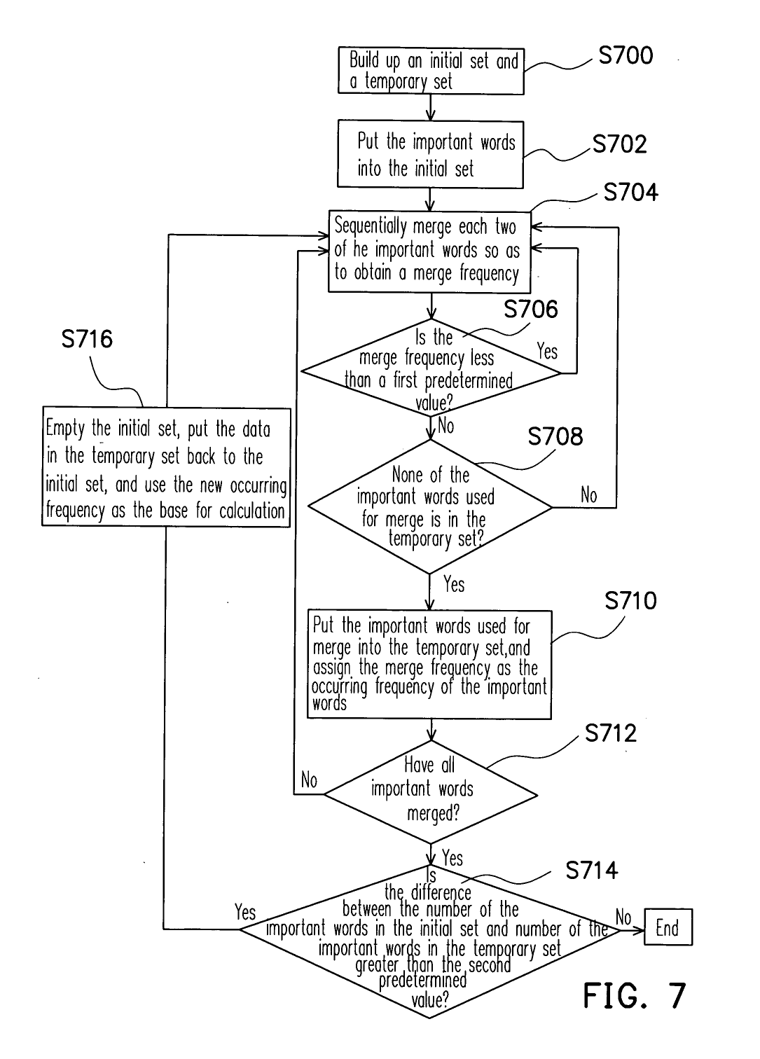

After the correlation Rᵢⱼ among each of the important words is obtained by the method mentioned above or others, a high-correlation keyword is further extracted. FIG. 7 is a flow chart illustrating a method for building a keyword repository according to a preferred embodiment of the present invention. In the present embodiment, an initial set S and a temporary set S^{T} are set up first (step S700). Then, the important words are put into the initial set (step S702), and each two of the important words (e.g. Kᵢₗ and Kᵢₘ) are sequentially merged in a descending order according to the sorting order of the correlation among the important words, and the following equation is used to obtain a corresponding merge frequency N′(Dᵢ, Wᵢₗ) (step S704):
N′(Dᵢ,Wᵢₗ)=N(Dᵢ,Wᵢₗ)+Rₗₘ*N(Dᵢ,Wᵢₘ)

If the merge frequency N′(Dᵢ, Wᵢₗ) obtained from the above equation is greater or equal to a certain first predetermined value which is determined previously, and two important words used for merge are not in the temporary set S^{T}, the process approaches to the step S710 after going through the steps S706 and S708. Wherein, in the step S710, the important word having a lower occurring frequency among the important words used for merge is put into the temporary set S^{T}, and the obtained merge frequency is used as a new occurring frequency of the important word put into the temporary set S^{T} currently.

Before determining whether all of the important words are merged in step S712, the steps S704˜S710 mentioned above are repeatedly performed. Once all of the important words have merged with each other, it is determined whether a difference of the number of the important words in the temporary set S^{T} and the number of the important words in the initial set S is greater than a second predetermined value in step S714. If the determining result of the step S714 is false, the important words in the temporary set S^{T} or in the initial set S are used as the keywords. Otherwise, if the determining result of the step S714 is true, the process approaches to the step S716 where the initial set S is emptied, then the important words in the temporary set S^{T} are put into the initial set S, and the temporary set S^{T} is emptied and the steps S704˜S714 are performed again. The judge in the step S714 is according to the following equation:
Min[N(S),N(S^{T})]−N(S∩S^{T})<ε

After performing the operations of the present embodiment, the occurring frequency among keywords is also modified. In addition, the keyword repository formed by each of the keywords generated by it can be further applied in various functions such as meaning analysis, index classification, information comparison, and fuzzy search.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for keyword correlation analysis, comprising:
obtaining a plurality of important words from a document repository; and
calculating a correlation among the important words according to at least one of a plurality of occurring frequencies and a plurality of occurring positions.

2. The method for keyword correlation analysis of claim 1, wherein the document repository comprises an enterprise knowledge-based management system and an enterprise document management system.

3. The method for keyword correlation analysis of claim 1, wherein the step of obtaining the important words comprises at least one of a plurality of techniques as follows: word byte analysis, word phrase analysis, word phrase comparison, word phrase frequency maintenance, keyword extraction from a candidate glossary repository, and keyword extraction from a to-be-confirmed glossary repository.

4. The method for keyword correlation analysis of claim 1, wherein the step of calculating the correlation among the important words according to the occurring frequencies of the important words comprises:
merging the occurring frequencies of the same important word; and
calculating a correlation of the occurring frequencies of the merged important words.

5. The method for keyword correlation analysis of claim 4, wherein the step of merging the occurring frequencies of the same important word comprises:
extracting the important words;
merging the important words which repeatedly occur; and
re-calculating the occurring frequency of the important words.

6. The method for keyword correlation analysis of claim 4, wherein the step of calculating the correlation of the occurring frequencies of the important words comprises:
obtaining the occurring frequencies of the important words; and
calculating a correlation factor of the occurring frequencies among each two of the important words, and assigning the correlation factor as the occurring frequency of the important words.

7. The method for keyword correlation analysis of claim 1, wherein the step of calculating the correlation among the important words according to the occurring positions of the important words comprises:
calculating a relative distance among the important words; and
calculating the correlation of the occurring positions of the important words according to the relative distance among the important words.

8. The method for keyword correlation analysis of claim 7, wherein the step of calculating the relative distance among the important words comprises:
calculating a shortest distance for each of the occurring positions among the important words, respectively; and
assigning the shortest distance as the relative distance.

9. The method for keyword correlation analysis of claim 7, wherein the step of calculating the relative distance among the important words comprises:
selecting a first important word and a second important word from the important words;
calculating a non-used shortest distance between the first important word and each of the occurring positions of the second important word by using the first important word as a base; and
assigning the non-used shortest distance as the relative distance,
wherein, the non-used shortest distance is a shortest instance between a current position of the second important word and one of the occurring positions of the first important word, which is not used to calculate the relative distance with respect to any occurring position of the second important word.

10. The method for keyword correlation analysis of claim 7, wherein the step of calculating the relative distance among the important words comprises:
selecting a first important word and a second important word from the important words;
calculating a subsequent shortest distance between the first important word and each of the occurring positions of the second important word by using the first important word as a base; and
assigning the subsequent shortest distance as the relative distance,
wherein, the subsequent shortest distance is a shortest instance between a current position of the second important word and one of the occurring positions of the first important word, which is subsequent to the previous occurring position used to calculate the relative distance with respect to the second important word.

11. The method for keyword correlation analysis of claim 7, wherein the step of calculating the correlation of the occurring positions among the important words according to the relative distance of the important words comprises:
obtaining the relative distance of the important words; and
calculating a correlation factor of the relative distances among the important words, and assigning the correlation factor as the correlation of the occurring positions among the important words.

12. The method for keyword correlation analysis of claim 1, wherein the step of calculating the correlation among the important words according to the occurring frequencies and the occurring positions of the important words comprises:
calculating the correlation of the occurring frequencies among each two of the important words, respectively;
calculating the correlation of the occurring positions among each two of the important words, respectively;
multiplying the correlation of the occurring frequencies and the correlation of the occurring positions among each two of the important words; and
assigning the multiplication result as the correlation of each two of the important words.

13. The method for keyword correlation analysis of claim 1, further comprising:
setting up an initial set and a temporary set;
putting the important words into the initial set;
sequentially merging each two of the important words according to a sorting order of the correlations among the important words, so as to obtain a corresponding merge frequency;
if the merge frequency is greater or equal to a first predetermined value and none of the important words used for merge is in the temporary set, the important word used for merge and having a lower occurring frequency is put into the temporary set, and the occurring frequency of the important word stored in the temporary set is replaced with the merge frequency;
repeatedly performing the above steps until all important words in the initial set are sequentially merged;
if a difference of a number of the important words in the temporary set and a number of the important words in the initial set is greater than a second predetermined value, the initial set is emptied and the important words in the temporary set are put back to the initial set, then the temporary set is emptied and the above steps are performed again; and
if the difference of the number of the important words in the temporary set and the number of the important words in the initial set is less than a second predetermined value, the important words in either the initial set or the temporary set are assigned as the keywords.
